(19) United States
(12) Patent Application Publication
(10) Pub. No.: US 2023/0169709 A1
(43) Pub. Date: Jun. 1, 2023

(54) FACE DE-IDENTIFICATION METHOD AND SYSTEM EMPLOYING FACIAL IMAGE GENERATION AND GUI PROVISION METHOD FOR FACE DE-IDENTIFICATION EMPLOYING FACIAL IMAGE GENERATION

(71) Applicant: Electronics and Telecommunications Research Institute, Daejeon (KR)

(72) Inventors: Dong Hyuck IM, Daejeon (KR); Jung Hyun KIM, Daejeon (KR); Hye Mi KIM, Daejeon (KR); Jee Hyun PARK, Daejeon (KR); Yong Seok SEO, Daejeon (KR); Won Young YOO, Daejeon (KR)

(73) Assignee: Electronics and Telecommunications Research Institute, Daejeon (KR)

(21) Appl. No.: 17/899,947

(22) Filed: Aug. 31, 2022

(30) Foreign Application Priority Data
Nov. 29, 2021 (KR) 10-2021-0167544

(51) Int. Cl. G06T 11/60; G06T 11/40; G06V 40/16; G06F 3/04842; G06F 3/04845

(52) U.S. Cl. CPC G06T 11/60; G06T 11/40; G06V 40/161; G06F 3/04842; G06F 3/04845

(57) ABSTRACT

Provided are a face de-identification method and system and a graphical user interface (GUI) provision method for face de-identification employing facial image generation. According to the face de-identification method and system and the GUI provision method, a facial area including eyes, a nose, and a mouth in a face of a person detected in an input image is replaced with a de-identified facial area generated through deep learning to maintain the face in a natural shape while protecting the person's portrait right. Accordingly, qualitative degradation of content is prevented, and viewers' concentration on the image is increased.

### CROSS-REFERENCE TO RELATED APPLICATION

This application claims priority to and the benefit of Korean Patent Application No. 10-2021-0167544 filed on Nov. 29, 2021, the disclosure of which is incorporated herein by reference in its entirety.

### BACKGROUND

### 1. Field of the Invention

The present disclosure relates to a face de-identification method and system and a graphical user interface (GUI) provision method employing facial image generation, and more particularly, to a face de-identification method and system and a GUI provision method for face de-identification employing facial image generation, the face de-identification method and system and the GUI provision method replacing a facial area including the eyes, the nose, and the mouth in the face of a person detected in an input image with a de-identified facial area generated through deep learning to maintain the face in a natural shape while protecting the person's portrait right so that qualitative degradation of content can be prevented and viewers' concentration on the image can be increased.

### 2. Discussion of Related Art

The recent development of smartphones facilitated posting images captured by individuals on websites, social network services (SNSs), etc. or sharing the images with others. Accordingly, problems with portrait rights or privacy violations arose. In other words, there have been cases where a person who does not want his or her face to be shown in an image is unintentionally captured in an image, and the image is posted online such that a creator of the image is alleged to have violated the person's portrait right or privacy.

As this happens frequently, image creators initially avoided allegations of violation of people's portrait rights or privacy by manually mosaicking or blurring the faces of people, who do not want their appearance in images or did not give their consent to their appearance in images, one by one.

Such a manual work requires considerable time and labor for image creators or editors. To solve this inconvenience, a system that automatically detects the face of a specific person in an image and mosaics or blurs the face was developed.

However, such an existing system merely detects a face and mosaics or blurs the face, and thus the content appears to be inferior from image viewers' points of view. Also, in the case of an image in which a large number of people appear, the image is distractive due to mosaic and blur such that it becomes difficult for viewers to concentrate on the image.

### SUMMARY OF THE INVENTION

The present disclosure is directed to providing a face de-identification method and system and a graphical user interface (GUI) provision method employing facial image generation, the face de-identification method and system and the GUI provision method replacing a facial area including eyes, a nose, and a mouth in a face of a person detected in an input image with a de-identified facial area generated through deep learning to maintain the face in a natural shape while protecting the person's portrait right so that qualitative degradation of content may be prevented and viewers' concentration on the image may be increased.

According to an aspect of the present invention, there is provided a face de-identification method employing facial image generation, the face de-identification method including a face detection operation of detecting a face of a person included in an input image from the input image, a front face adjustment operation of adjusting the face as a front face, a facial area deletion operation of deleting a facial area including eyes, a nose, and a mouth in the adjusted front face, a facial area generation operation of generating a de-identified facial area for replacing the deleted facial area using deep learning, a facial area filling operation of filling the deleted facial area with the de-identified facial area, and a facial area alignment operation of aligning eyes, a nose, and a mouth in the de-identified facial area with the face detected in the input image.

The facial area generation operation may include training a deep learning network with a plurality of pieces of facial image training data to generate an image generation model and generating the de-identified facial area using the image generation model.

The facial area generation operation may include a codebook training operation of training and generating a codebook to represent the plurality of pieces of facial image training data with block codebook indices and an image generation model training operation of training and generating the image generation model so that the image generation model may learn the plurality of pieces of facial image training data represented with the codebook indices through the trained codebook and generate the de-identified facial area with a combination of codebook indices.

The codebook training operation may include training and generating the codebook by training a quantized codebook, an encoder which encodes the plurality of pieces of facial image training data with the codebook indices, and a decoder which generates the de-identified facial area by reconstructing an image with the encoded codebook indices.

In the codebook training operation, when the codebook is trained and generated, an objective function for finding an optimal compression model Q* may be defined as Equation 1 below.

$${𝒬}^{⋆} = {arg min}_{E , G , Z} {max}_{D} {E}_{z \sim p ( x )} [ {ℒ}_{VQ} ( E , G , Z ) + {λℒ}_{GAN} ( \{ E , G , Z \} , D ) ] \qquad [ Equation 1 ]$$

Here, E denotes the encoder, G denotes the decoder, Z denotes the codebook, D denotes a discriminator, x denotes the image, p denotes a probability distribution value, L_{VQ} denotes a loss function that is related to codebook training and set to reduce loss when an image is reconstructed in an encoding or decoding process, L_{GAN} denotes a generative adversarial network (GAN) loss function which ensures that an image generated using a codebook does not differ in picture quality from an original image, and λ denotes a ratio of an instantaneous change rate of L_{VQ} to that of L_{GAN}.

Accordingly, the codebook training operation may include performing learning to reduce the sum of L_{VQ} and L_{GAN}.

$$λ = \frac{{∇}_{{G}_{L}} [ {L}_{VQ} ]}{∇ {G}_{L} [ {L}_{GAN} ] + δ} \qquad [ Equation 2 ]$$

Here, ∇_{G}_{_{L}}[·] denotes a differential coefficient of a final layer input to the decoder, and δ denotes a constant.

The image generation model training operation may include training and generating the image generation model using a bidirectional encoder representations from transformers (BERT) model that covers some tokens with a mask among the codebook indices in the facial image training data represented with the codebook indices and predicts what are the tokens covered with the mask by referring to previous and subsequent tokens of the tokens covered with the mask.

In the image generation model training operation, when the image generation model is trained and generated, a loss function L_{MLM} may be defined as Equation 3 below.

$${L}_{MLM} = {𝔼}_{χ} [ \frac{1}{K} {\sum }_{k = 1}^{K} - log p ( {x}_{{π}_{k}} \vert {X}_{- \prod } , θ ) ] \qquad [ Equation 3 ]$$

Here, when an input sentence corresponding to the codebook indices of the facial image training data is X and indices of the tokens covered with the mask are Π={π₁, π₂, . . . , π_{K}}, X_{Π} may be defined as a set of tokens covered with the mask in the input sentence, X_{-Π} may be defined as a set of tokens not covered with the mask in the input sentence, and θ denotes a parameter of a transformer, training the image generation model to minimize a negative log-likelihood of X_{Π} in L_{MLM}.

The facial area generation operation may further include generating the de-identified facial area by predicting tokens for filling token portions corresponding to the deleted facial area among codebook indices of the front face from which the facial area including the eyes, the nose, and the mouth is deleted.

According to another aspect of the present invention, there is provided a GUI provision method for face de-identification employing facial image generation, the GUI provision method including a face detection operation of detecting faces of people included in an input image from the input image, a face selection operation of receiving an input of a user to select a face to be de-identified among the detected faces, a de-identified facial area generation operation of generating a plurality of de-identified facial in which a facial area including eyes, a nose, and a mouth is changed in the selected face using deep learning, an image display operation of displaying the plurality of de-identified facial areas as a plurality of images, and a face de-identification operation of displaying a de-identified facial area corresponding to an image selected by an input of the user among the plurality of images in place of the facial area of the face selected in the face selection operation.

According to another aspect of the present invention, there is provided a face de-identification system employing facial image generation, the face de-identification system including a face detector configured to detect a face of a person included in an input image from the input image, a front face adjuster configured to adjust the face as a front face, a facial area deleter configured to delete a facial area including eyes, a nose, and a mouth in the adjusted front face, a facial area generator configured to generate a de-identified facial area for replacing the deleted facial area using deep learning and fill the deleted facial area with the de-identified facial area, and a facial area aligner configured to align eyes, a nose, and a mouth in the de-identified facial area with the face detected in the input image.

The facial area generator may train a deep learning network with a plurality of pieces of facial image training data to generate an image generation model and may generate the de-identified facial area using the image generation model.

The facial area generator may include a codebook trainer configured to train and generate a codebook to represent the plurality of pieces of facial image training data with block-specific codebook indices and an image generation model trainer configured to train and generate the image generation model so that the image generation model may learn the plurality of pieces of facial image training data represented with the codebook indices through the trained codebook and generate the de-identified facial area with a combination of codebook indices.

The codebook trainer may train and generate the codebook by training a quantized codebook, an encoder which encodes the plurality of pieces of facial image training data with the codebook indices, and a decoder which generates the de-identified facial area by reconstructing an image with the encoded codebook indices.

The image generation model trainer may train and generate the image generation model using a BERT model that covers some tokens with a mask among the codebook indices in the facial image training data represented with the codebook indices and predicts what are the tokens covered with the mask by referring to previous and subsequent tokens of the tokens covered with the mask.

The facial area generator may predict tokens for filling token portions corresponding to the deleted facial area among codebook indices of the front face from which the facial area including the eyes, the nose, and the mouth is deleted to generate the de-identified facial area.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a flowchart illustrating a face de-identification method employing facial image generation according to an exemplary embodiment of the present invention;

FIGS. 2A, 2B, 2C, 2D, 2E, 2F and 2G are an implementation example of the face de-identification method employing facial image generation according to the exemplary embodiment of the present invention;

FIG. 3 is a diagram illustrating a process of training an image generation model in a facial area generation operation of the face de-identification method employing facial image generation according to the exemplary embodiment of the present invention;

FIG. 4 is an implementation example of the process of training an image generation model in the facial area generation operation of the face de-identification method employing facial image generation according to the exemplary embodiment of the present invention;

FIG. 5 is a diagram illustrating an example of generating a de-identified facial area in the facial area generation operation of the face de-identification method employing facial image generation according to the exemplary embodiment of the present invention;

FIGS. 6A and 6B are a set of examples of face de-identification performed with the face de-identification method employing facial image generation according to the exemplary embodiment of the present invention;

FIG. 7 is a flowchart illustrating a graphical user interface (GUI) provision method for face de-identification employing facial image generation according to an exemplary embodiment of the present invention;

FIGS. 8A and 8B are a diagram illustrating an implementation example of the GUI provision method for face de-identification employing facial image generation according to the exemplary embodiment of the present invention; and

FIG. 9 is a diagram illustrating a face de-identification system employing facial image generation according to an exemplary embodiment of the present invention.

### DETAILED DESCRIPTION OF EXEMPLARY EMBODIMENTS

The present disclosure will be described in detail below with reference to the accompanying drawings. Repeated descriptions and detailed descriptions of known functions and configurations that may obscure the gist of the present disclosure will be omitted. Embodiments of the present disclosure are provided to more fully describe the present disclosure to those of ordinary skill in the art. Therefore, the shapes, sizes, etc. of elements in the drawings may be exaggerated for clarity.

Throughout the specification, when any part is referred to as “including” any element, this does not exclude other elements, but may further include other elements unless otherwise stated.

Also, the term “part” used herein means a unit of processing one or more functions or operations, and the “part” may be implemented as software, hardware, or a combination of software and hardware.

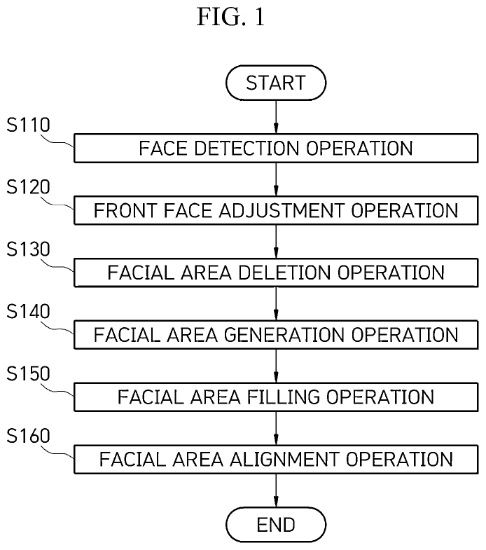

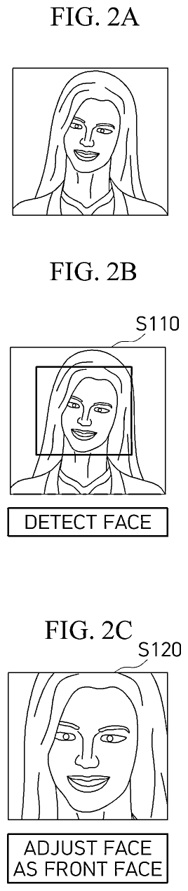

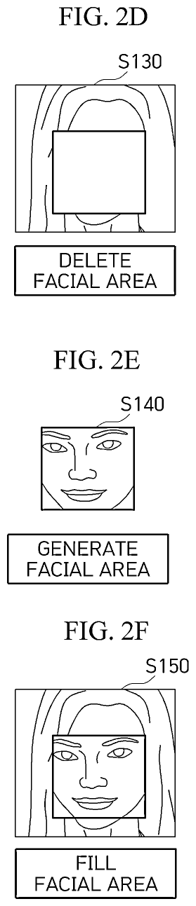

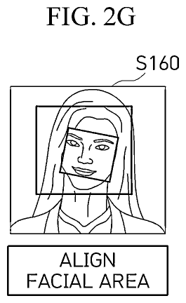

Hereinafter, a face de-identification method employing facial image generation according to an exemplary embodiment of the present disclosure will be described with reference to FIG. 1 and FIGS. 2A, 2B, 2C, 2D, 2E, 2F and 2G.

FIG. 1 is a flowchart illustrating a face de-identification method employing facial image generation according to an exemplary embodiment of the present invention, and FIGS. 2A, 2B, 2C, 2D, 2E, 2F and 2G are an implementation example of the face de-identification method employing facial image generation according to the exemplary embodiment of the present invention.

Referring to FIG. 1 and FIGS. 2A, 2B, 2C, 2D, 2E, 2F and 2G, when the face de-identification method employing facial image generation according to the exemplary embodiment of the present disclosure begins, first, a face of a person included in an input image (see FIG. 2A) is detected from the input image (see FIG. 2B) in a face detection operation S110.

In a front face adjustment operation S120 (see FIG. 2C), the face detected in the face detection operation S110 is adjusted as a front face. Adjusting the face as the front face is to facilitate matching of a de-identified facial area to be generated later with the detected face. According to the exemplary embodiment, in the front face adjustment operation S120, landmarks of the face, such as eyes, a nose, lip corners, etc., may be detected, and the face may be adjusted as a front face on the basis of coordinates of the landmarks.

In a facial area deletion operation S130 (see FIG. 2D), a facial area including the eyes, the nose, and the mouth is deleted from the adjusted front face. In the present invention, to de-identify a face, it is simply necessary to replace a facial area including eyes, a nose, and a mouth, and it is unnecessary to replace an overall face detected in an input image. Accordingly, in the facial area deletion operation S130, only the facial area including the eyes, the noise, and the mouth is deleted.

In a facial area generation operation S140 (see FIG. 2E), a de-identified facial area for replacing the deleted facial area is generated using deep learning. The de-identified facial area generated in the facial area generation operation S140 differs from the existing facial area, and the face in which the facial area is replaced with the de-identified facial area corresponds to a virtual person who does not actually exist. Accordingly, it is possible to solve the problem of infringement of portrait rights or privacy. A specific exemplary embodiment or implementation example of the facial area generation operation S140 will be described in further detail below with reference to another drawing.

In a facial area filling operation S150 (see FIG. 2F), the deleted facial area is filled with the de-identified facial area generated in the facial area generation operation S140.

In the facial area alignment operation S160 (see FIG. 2G), eyes, a nose, and a mouth of the de-identified facial area are aligned with the face detected in the input image. Since the face is adjusted as the front face in the front face adjustment operation S120, the eyes, the noise, and the mouth of the de-identified facial area are aligned with the direction of the face detected in the input image. Accordingly, it is possible to obtain a face of a virtual person that is natural and not strange.

A process of training an image generation.

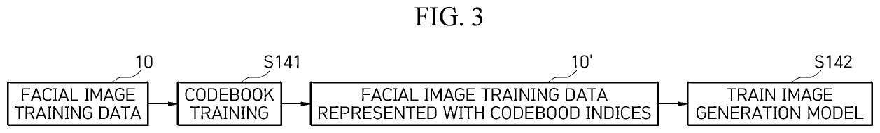

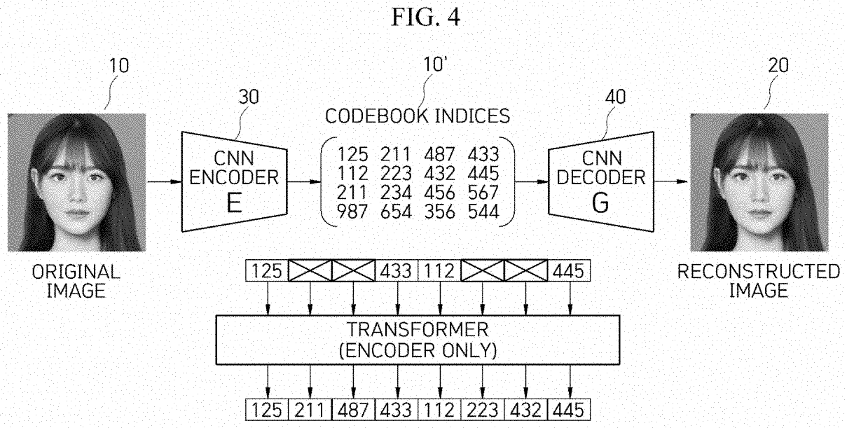

n model in the facial area generation operation of the face de-identification method employing facial image generation according to the exemplary embodiment of the present disclosure will be described in detail below with reference to FIGS. 3 and 4.

FIG. 3 is a diagram illustrating a process of training an image generation model in a facial area generation operation of the face de-identification method employing facial image generation according to the exemplary embodiment of the present invention, and FIG. 4 is an implementation example of the process of training an image generation model in the facial area generation operation of the face de-identification method employing facial image generation according to the exemplary embodiment of the present invention.

Referring to FIGS. 3 and 4, in the facial area generation operation S140 of the face de-identification method employing facial image generation according to the exemplary embodiment of the present invention, an image generation model may be generated by training a deep learning network with a plurality of pieces of facial image training data 10, and the de-identified facial area may be generated using the image generation model. As shown in FIG. 4, the deep learning network used in the facial area generation operation S140 may be a convolutional neural network (CNN).

The facial area generation operation S140 of the face de-identification method employing facial image generation according to the exemplary embodiment of the present disclosure may include a codebook training operation S141 of training and generating a codebook to represent the plurality of pieces of facial image training data 10 with block-specific codebook indices and an image generation model training operation S142 of training and generating the image generation model so that the image generation model may learn a plurality of pieces of facial image training data 10′ represented with the codebook indices through the trained codebook and generate the de-identified facial area with a combination of codebook indices.

In the codebook training operation S141, the codebook is trained first so that images of the plurality of pieces of facial image training data 10 may be represented with block-specific codebook indices rather than pixel-specific codebook indices. The facial image training data 10 used for training may be a facial image that is aligned to the front.

According to the exemplary embodiment, in the codebook training operation S141, the codebook may be trained and generated by training a quantized codebook, an encoder 30 which encodes the plurality of pieces of facial image training data with the codebook indices, and a decoder 40 which generates a de-identified facial area 20 by reconstructing an image with the encoded codebook indices.

In the codebook training operation S141, a generative adversarial network (GAN) training procedure is used together with a patch-based discriminator to show good performance without any degradation in terms of picture quality even while enlarging a block size.

In the case of training and generating a codebook in the codebook training operation S141, an objective function for finding an optimal compression model Q* may be defined as Equation 1 below.

$${𝒬}^{⋆} = {arg min}_{E , G , Z} {max}_{D} {E}_{z \sim p ( x )} [ {ℒ}_{VQ} ( E , G , Z ) + {λℒ}_{GAN} ( \{ E , G , Z \} , D ) ] \qquad [ Equation 1 ]$$

Here, E denotes the encoder, G denotes the decoder, Z denotes the codebook, D denotes a discriminator, x denotes an image, p denotes a probability distribution value, L_{VQ} denotes a loss function that is related to codebook training and set to reduce loss when an image is reconstructed in an encoding or decoding process, L_{GAN} denotes a GAN loss function which ensures that an image generated using a codebook does not differ in picture quality from an original image, and λ denotes a ratio of an instantaneous change rate of L_{VQ} to that of L_{GAN}.

Here, in the codebook training operation S141, learning may be performed to reduce the sum of L_{VQ} and L_{GAN}.

Equation 2 below is an equation for calculating λ through the instantaneous change rate of L_{VQ} to that of L_{GAN}.

$$λ = \frac{{∇}_{{G}_{L}} [ {L}_{VQ} ]}{∇ {G}_{L} [ {L}_{GAN} ] + δ} \qquad [ Equation 2 ]$$

Here ∇_{G}_{_{L}}[·] denotes a differential coefficient of a final layer input to the decoder, and δ denotes a constant.

In the image generation model training operation S142, the image generation model is trained to generate an image with a combination of codebook indices. According to the exemplary embodiment, in the image generation model training operation S142, the image is represented as the continuance of quantized codebook indices (words), and then the image generation model is trained. When a block size is determined to be 16 horizontal pixels by 16 vertical pixels and each block is represented as one codebook index, a 256×256 pixel image may be represented with 256 continuous codebook indices.

According to the exemplary embodiment, in the image generation model training operation S142, the image generation model may be trained and generated using a bidirectional encoder representations from transformers (BERT) model that covers some tokens with a mask among the codebook indices in the facial image training data 10′ represented with the codebook indices and predicts what are the tokens covered with the mask by referring to previous and subsequent tokens of the tokens covered with the mask.

Face de-identification to be solved through the present disclosure is a process of forcibly omitting a main area of a facial image and predicting the corresponding area. When an image is encoded using a codebook, the image is literally converted in the form of codebook indices. Accordingly, face de-identification may be considered the same problem as a method of predicting a missing word in a sentence. Among deep learning language models, the BERT model currently shows good performance in the word prediction field. The BERT model is a model designed using an encoder part of a transformer structure. Here, a “direction” means a direction in which words are referred to after any word in the middle of a sentence is referred to. In the case of a unidirectional language model, for example, in generative pre-training (GPT), attention is performed by only referring to words in front of a corresponding word in a sentence. On the other hand, a bidirectional language model refers to all words in front of and behind a corresponding word. In BERT, bidirectional reference is implemented through a masked language model (MLM). The MLM covers some of input tokens (words) with a mask and predicts what the covered tokens are. This is to learn the fill-in-the-blank problem of sentences, and the model trained in this process develops a capability to understand the context.

In the case of training and generating an image generation model in the image generation model training operation S142, a loss function L_{MLM} may be defined as Equation 3 below:

$${L}_{MLM} = {𝔼}_{χ} [ \frac{1}{K} {\sum }_{k = 1}^{K} - log p ( {x}_{{π}_{k}} \vert {X}_{- \prod } , θ ) ] \qquad [ Equation 3 ]$$

Here, when an input sentence corresponding to codebook indices of facial image training data is X and indices of tokens covered with a mask are Π={π₁, π₂, . . . , π_{K}}, X_{Π} may be defined as a set of tokens covered with the mask in the input sentence, and X_{-Π} may be defined as a set of tokens not covered with the mask in the input sentence. θ denotes a parameter of a transformer. In the image generation model training operation S142, the image generation model may be trained to minimize a negative log-likelihood of X_{Π} in L_{MLM}. The masked tokens may be predicted through a final softmax layer.

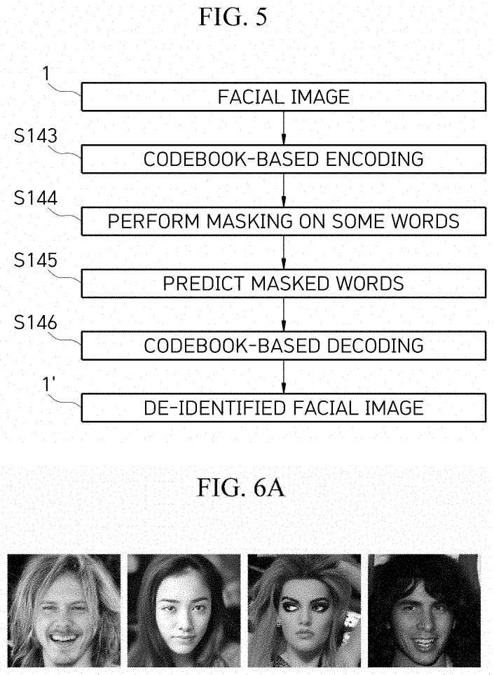

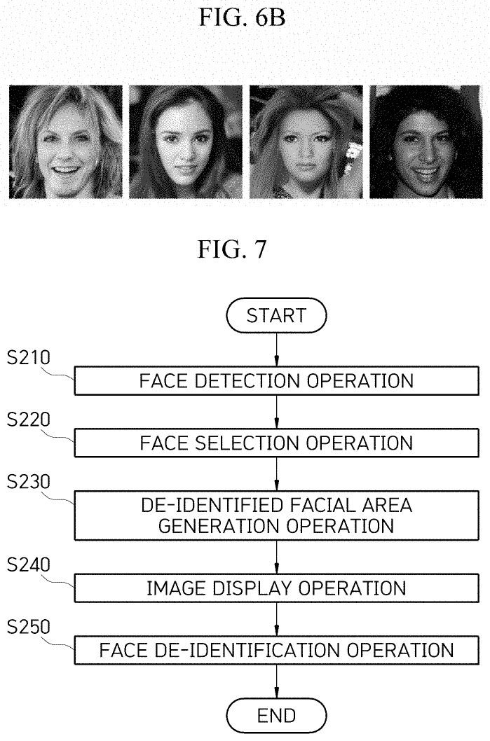

A process of generating a de-identified facial area in the facial area generation operation of the face de-identification method employing facial image generation according to the exemplary embodiment of the present disclosure will be described below with reference to FIGS. 5 and 6.

FIG. 5 is a diagram illustrating an example of generating a de-identified facial area in the facial area generation operation of the face de-identification method employing facial image generation according to the exemplary embodiment of the present invention.

Referring to FIG. 5, a general process of generating a de-identified facial area in the facial area generation operation S140 of the face de-identification method employing facial image generation according to the exemplary embodiment of the present disclosure is illustrated. When an adjusted facial image 1 is input, encoding is performed on the basis of a codebook (S143) such that the image is changed to consecutive codebook indices (words). Some of the words are masked (S144), and then words are predicted using a BERT model for predicting masked words (S145). As a prediction method, a word having the highest probability value output from a softmax layer may be selected, and a top-K sampling method of selecting K candidates having a high probability value and then performing sampling, etc. may be used. When the predicted words and non-masked words are aggregated and then decoded on the basis of the codebook (S146), a facial image 1′ is generated. The generated facial image 1′ is a de-identified image different from the input facial image.

Through this process, in the facial area generation operation S140, tokens for filling token portions corresponding to the deleted facial area among codebook indices of the front face are predicted using the BERT model for the front face from which the facial area including the eyes, the nose, and the mouth is deleted, and thus a de-identified facial area can be generated.

FIGS. 6A and 6B are a set of examples of face de-identification performed with the face de-identification method employing facial image generation according to the exemplary embodiment of the present invention.

FIGS. 6A and 6B shows pairs of original facial images (see FIG. 6A) included in an input image and de-identified facial images (see FIG. 6B). The upper facial images are original facial images (see FIG. 6A) included in the input image, and the lower facial images are de-identified facial images (see FIG. 6B) generated according to the proposed method. The generated de-identified facial images (see FIG. 6B) are de-identified to be different from the original facial images (see FIG. 6A) but are natural facial images. In the face de-identification method employing facial image generation according to the exemplary embodiment, a more different image from an original image may be obtained when a larger area is masked.

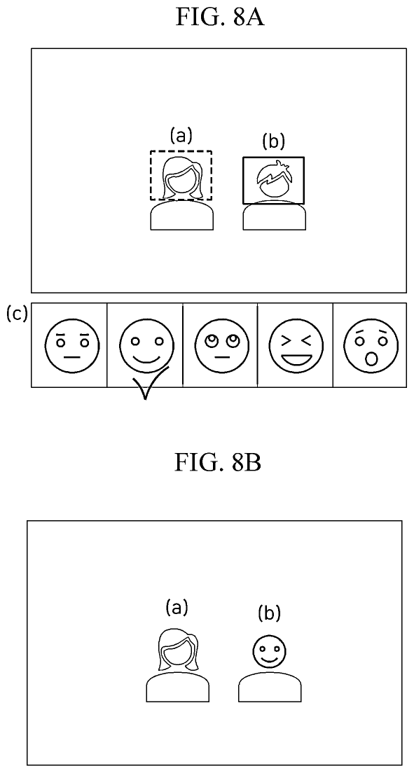

A graphical user interface (GUI) provision method for face de-identification employing facial image generation according to an exemplary embodiment of the present disclosure will be described below with reference to FIGS. 7 and 8.

FIG. 7 is a flowchart illustrating a GUI provision method for face de-identification employing facial image generation according to the exemplary embodiment of the present invention, and FIGS. 8A and 8B are a diagram illustrating an implementation example of the GUI provision method for face de-identification employing facial image generation according to the exemplary embodiment of the present invention.

Referring to FIG. 7, FIGS. 8A and 8B, when the GUI provision method for face de-identification employing facial image generation according to the exemplary embodiment of the present disclosure begins, first, faces (a and b in FIG. 8A) of people included in an input image are detected from the input image in a face detection operation S210.

In a face selection operation S220, a face (b in FIG. 8A) to be de-identified is selected by receiving an input of a user.

In a de-identified facial area generation operation S230, a plurality of de-identified facial areas that are obtained by changing a facial area including eyes, a nose, and a mouth in the detected face are generated using deep learning. As a method of generating the plurality of de-identified facial areas, a method of generating a de-identified facial area in the facial area generation operation S140 described above with reference to FIGS. 3, 4, 5, 6A and 6B may be used.

In an image display operation S240, the plurality of de-identified facial areas are displayed as a plurality of images (c in FIG. 8A).

In a face de-identification operation S250, the facial area of the face (b in FIG. 8b) selected in the face selection operation S220 is replaced with a de-identified facial corresponding selected from among the plurality of a de-identified facial images (c in FIG. 8A).

With the GUI provision method for face de-identification employing facial image generation according to the exemplary embodiment of the present invention, the user can easily select a face to be de-identified and select a face to which the face to be de-identified will be changed.

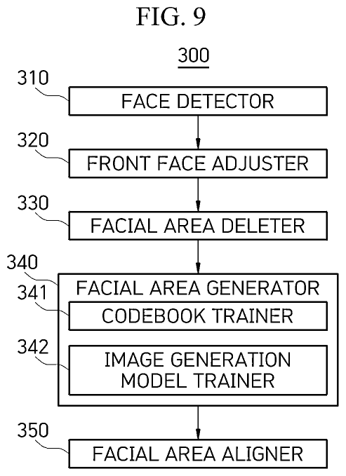

FIG. 9 is a diagram illustrating a face de-identification system employing facial image generation according to an exemplary embodiment of the present invention.

Referring to FIG. 9, a face de-identification system 300 employing facial image generation according to an exemplary embodiment of the present disclosure includes a face detector 310, a front face adjuster 320, a facial area deleter 330, a facial area generator 340, and a facial area aligner 350. The face de-identification system 300 employing facial image generation shown in FIG. 9 is in accordance with the exemplary embodiment. Elements shown in FIG. 9 are not limited to the exemplary embodiment shown in FIG. 9 and may be added, changed, or omitted as necessary.

The face detector 310 detects a face of a person included in an input image from the input image.

The front face adjuster 320 adjusts the face detected by the face detector 310 as a front face.

The facial area deleter 330 deletes a facial area including eyes, a nose, and a mouth from the front face adjusted by the front face adjuster 320.

The facial area generator 340 generates a de-identified facial area for replacing the facial area deleted by the facial area deleter 330 using deep learning and fills the deleted facial area with the de-identified facial area.

According to the exemplary embodiment, the facial area generator 340 may include a codebook trainer 341 that trains and generates a codebook to represent a plurality of pieces of facial image training data with block-specific codebook indices and an image generation model trainer 342 that trains and generates an image generation model so that the image generation model may learn a plurality of pieces of facial image training data which are represented with codebook indices through the trained codebook and generate a de-identified facial area with a combination of codebook indices.

The facial area aligner 350 aligns eyes, a nose, and a mouth in the de-identified facial area with the face detected from the input image.

Each element of the face de-identification system 300 employing facial image generation according to the exemplary embodiment of the present disclosure may perform each of the operations S110 to S160 of the above-described face de-identification method employing facial image generation, and the face de-identification system 300 employing facial image generation according to the exemplary embodiment of the present disclosure performs face de-identification in a similar way to the above-described face-de-identification method employing facial image generation. Accordingly, detailed descriptions of the face de-identification system 300 employing facial image generation according to the exemplary embodiment of the present disclosure will be omitted to prevent a reiteration.

According to an aspect of the present invention, it is possible to provide a face de-identification method and system and a GUI provision method employing facial image generation, the face de-identification method and system and the GUI provision method replacing a facial area including eyes, a nose, and a mouth in a face of a person detected in an input image with a de-identified facial area generated through deep learning to maintain the face in a natural shape while protecting the person's portrait right so that qualitative degradation of content can be prevented and viewers' concentration on the image can be increased.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

In the foregoing, specific embodiments of the present disclosure have been described, but the technical scope of the present disclosure is not limited to the accompanying drawings and the described contents. Those of ordinary skill in the art will appreciate that various modifications are possible without departing from the spirit of the present invention, and the modifications are construed as belonging to the claims of the present disclosure without violating the spirit of the present invention.

What is claimed is:

1. A face de-identification method employing facial image generation, the face de-identification method comprising:
a face detection operation of detecting a face of a person included in an input image from the input image;
a front face adjustment operation of adjusting the face as a front face;
a facial area deletion operation of deleting a facial area including eyes, a nose, and a mouth in the adjusted front face;
a facial area generation operation of generating a de-identified facial area for replacing the deleted facial area using deep learning;
a facial area filling operation of filling the deleted facial area with the de-identified facial area; and
a facial area alignment operation of aligning eyes, a nose, and a mouth in the de-identified facial area with the face detected in the input image.

2. The face de-identification method of claim 1, wherein the facial area generation operation comprises:
training a deep learning network with a plurality of pieces of facial image training data to generate an image generation model; and
generating the de-identified facial area using the image generation model.

3. The face de-identification method of claim 2, wherein the facial area generation operation comprises:
a codebook training operation of training and generating a codebook to represent the plurality of pieces of facial image training data with block-specific codebook indices; and
an image generation model training operation of training and generating the image generation model so that the image generation model learns the plurality of pieces of facial image training data represented with the codebook indices through the trained codebook and generates the de-identified facial area with a combination of codebook indices.

4. The face de-identification method of claim 3, wherein the codebook training operation comprises training and generating the codebook by training a quantized codebook, an encoder which encodes the plurality of pieces of facial image training data with the codebook indices, and a decoder which generates the de-identified facial area by reconstructing an image with the encoded codebook indices.

5. The face de-identification method of claim 4, wherein, in the codebook training operation, when the codebook is trained and generated, an objective function for finding an optimal compression model Q* is defined as Equation 1 below:
$${𝒬}^{⋆} = {arg min}_{E , G , Z} {max}_{D} {E}_{z \sim p ( x )} [ {ℒ}_{VQ} ( E , G , Z ) + {λℒ}_{GAN} ( \{ E , G , Z \} , D ) ] \qquad [ Equation 1 ]$$
where E denotes the encoder, G denotes the decoder, Z denotes the codebook, D denotes a discriminator, x denotes the image, p denotes a probability distribution value, L_{VQ} denotes a loss function that is related to codebook training and set to reduce loss when an image is reconstructed in an encoding or decoding process, L_{GAN} denotes a generative adversarial network (GAN) loss function which ensures that an image generated using the codebook does not differ in picture quality from the original image, and λ denotes a ratio of an instantaneous change rate of L_{VQ} to that of L_{GAN},
wherein λ is calculated through a ratio of an instantaneous change rate of L_{VQ} to that of L_{GAN} according to Equation 2 below:
$$λ = \frac{{∇}_{{G}_{L}} [ {L}_{VQ} ]}{∇ {G}_{L} [ {L}_{GAN} ] + δ} \qquad [ Equation 2 ]$$
where ∇_{G}_{_{L}}[·] denotes a differential coefficient of a final layer input to the decoder, and δ denotes a constant.

6. The face de-identification method of claim 3, wherein the image generation model training operation comprises training and generating the image generation model using a bidirectional encoder representations from transformers (BERT) model that covers some tokens with a mask among the codebook indices in the facial image training data represented with the codebook indices and predicts what are the tokens covered with the mask by referring to previous and subsequent tokens of the tokens covered with the mask.

7. The face de-identification method of claim 6, wherein, in the image generation model training operation, when the image generation model is trained and generated, a loss function L_{MLM} is defined as Equation 3 below:
$${L}_{MLM} = {𝔼}_{χ} [ \frac{1}{K} {\sum }_{k = 1}^{K} - log p ( {x}_{{π}_{k}} \vert {X}_{- \prod } , θ ) ] \qquad [ Equation 3 ]$$
where, when an input sentence corresponding to the codebook indices of the facial image training data is X and indices of the tokens covered with the mask are Π={π₁, π₂, . . . , π_{K}}, X_{Π} is defined as a set of tokens covered with the mask in the input sentence, X_{-Π} is defined as a set of tokens not covered with the mask in the input sentence, and θ denotes a parameter of a transformer, training the image generation model to minimize a negative log-likelihood of X_{Π} in L_{MLM}.

8. The face de-identification method of claim 6, wherein the facial area generation operation further comprises generating the de-identified facial area by predicting tokens for filling token portions corresponding to the deleted facial area among codebook indices of the front face from which the facial area including the eyes, the nose, and the mouth is deleted.

9. A graphical user interface (GUI) provision method for face de-identification employing facial image generation, the GUI provision method comprising:
a face detection operation of detecting faces of people included in an input image from the input image;
a face selection operation of receiving an input of a user to select a face to be de-identified among the detected faces;
a de-identified facial area generation operation of generating a plurality of de-identified facial areas in which a facial area including eyes, a nose, and a mouth is changed in the selected face using deep learning;
an image display operation of displaying the plurality of de-identified facial areas as a plurality of images; and
a face de-identification operation of displaying a de-identified facial area corresponding to an image selected by an input of the user among the plurality of images in place of the facial area of the face selected in the face selection operation.

10. A face de-identification system employing facial image generation, the face de-identification system comprising:
a face detector configured to detect a face of a person included in an input image from the input image;
a front face adjuster configured to adjust the face as a front face;
a facial area deleter configured to delete a facial area including eyes, a nose, and a mouth in the adjusted front face;
a facial area generator configured to generate a de-identified facial area for replacing the deleted facial area using deep learning and fill the deleted facial area with the de-identified facial area; and
a facial area aligner configured to align eyes, a nose, and a mouth in the de-identified facial area with the face detected in the input image.

11. The face de-identification system of claim 10, wherein the facial area generator trains a deep learning network with a plurality of pieces of facial image training data to generate an image generation model and generates the de-identified facial area using the image generation model.

12. The face de-identification system of claim 11, wherein the facial area generator comprises:
a codebook trainer configured to train and generate a codebook to represent the plurality of pieces of facial image training data with block-specific codebook indices; and
an image generation model trainer configured to train and generate the image generation model so that the image generation model learns the plurality of pieces of facial image training data represented with the codebook indices through the trained codebook and generates the de-identified facial area with a combination of codebook indices.

13. The face de-identification system of claim 12, wherein the codebook trainer trains and generates the codebook by training a quantized codebook, an encoder which encodes the plurality of pieces of facial image training data with the codebook indices, and a decoder which generates the de-identified facial area by reconstructing an image with the encoded codebook indices.

14. The face de-identification system of claim 12, wherein the image generation model trainer trains and generates the image generation model using a bidirectional encoder representations from transformers (BERT) model that covers some tokens with a mask among the codebook indices in the facial image training data represented with the codebook indices and predicts what are the tokens covered with the mask by referring to previous and subsequent tokens of the tokens covered with the mask.

15. The face de-identification system of claim 14, wherein the facial area generator predicts tokens for filling token portions corresponding to the deleted facial area among codebook indices of the front face from which the facial area including the eyes, the nose, and the mouth is deleted to generate the de-identified facial area.
